(19) United States
(12) Patent Application Publication
(10) Pub. No.: US 2009/0195459 A1
(43) Pub. Date: Aug. 6, 2009

(54) ULTRA WIDEBAND ANTENNA

(75) Inventor: Lye-Whatt Chua, Surrey (GB)

Correspondence Address: LOWE HAUPTMAN & BERNER, LLP, 1700 DIAGONAL ROAD, SUITE 300, ALEXANDRIA, VA, 22314, US

(73) Assignee: Thales Holdings UK PLC, Addlestone, Surry (GB)

(21) Appl. No.: 12/301,684

(22) PCT Filed: Jun. 13, 2007
(86) PCT No.: PCT/EP07/55842

§ 371 Date: Nov. 20, 2008

(30) Foreign Application Priority Data
Jun. 13, 2006 (GB) 0611673.5

(51) Int. Cl. H01Q 9/04

(52) U.S. Cl. 343/700 MS; 29/600

(57) ABSTRACT

An antenna printed on a dielectric substrate having a radiating element and a transmission line printed on a front surface of the dielectric substrate and a ground element printed on a back surface of the dielectric substrate. The radiating element has a tapered shape with a narrow end connected to a first end of the transmission line, and two opposing edges of the radiating element contiguous to the transmission line. The radiating element further has a v-shaped notch distal from the first end of the transmission line wherein a broader end of the v-shaped notch having two opposing ends contiguous to the opposing edges of the radiating element thereby forming a two symmetrical lobes which diverge with increasing distance from the first end of the transmission line. The opposing edges of the radiating element further having a plurality of serrations along its length thereby forming a slow wave structure for signal propagating along the edges.

### CROSS-REFERENCE TO RELATED APPLICATIONS

The present Application is based on International Application No. PCT/EP2007/055842, filed on Jun. 13, 2007, which in turn corresponds to Great Britain Application No. 0611673.5 filed on Jun. 13, 2006, and priority is hereby claimed under 35 USC §119 based on these applications. Each of these applications are hereby incorporated by reference in their entirety into the present application.

### FIELD OF THE INVENTION

The present invention relates to antennas, and more particularly to antennas for radiating ultra wide bandwidth (UWB) pulses.

### BACKGROUND OF THE INVENTION

Pulsed electromagnetic (e/m) energy transmission and reception systems typically possess wide-band or UWB transmission spectral bandwidths. This UWB characteristic stems from the pulsed nature of the e/m energy transmitted and received by systems. The shape of such energy pulses in the time-domain is typically one of any number of approximations to a delta function, and generally has the property that the width of the frequency spectrum of such impulse increases as the time-domain “length” or duration of the pulse decreases. Thus, the shorter the pulse of radiation is the broader is its spectral bandwidth.

Ultra-Wideband was previously defined as an impulse radio, but those skilled in the art now view it as an available bandwidth set with an emissions limit that enables coexistence without harmful interference. One of the challenges of the implementation of UWB systems is the development of a suitable antenna that would enhance the advantages promised by a pulsed communication system. UWB systems require antennas that cover multi-octave bandwidths in order to transmit pulses on the order of a nanosecond in duration with minimal distortion.

The UWB performances of antennas result from excitation by impulse or non-sinusoidal signals with rapidly time-varying performances. Thus, when an antenna is used employing such pulses in UWB applications, it is often found that the time-domain behaviour of the antenna is critical to the operation of the antenna. In particular, if an impedance mismatch or discontinuity occurs in such an antenna (such as at the open circuit end of the antenna), the consequence is often the unwanted generation of a standing wave of e/m energy within the antenna's radiating element(s) caused by reflections within the antenna of the e/m energy to be transmitted.

This trapped energy not only reduces the efficiency of the transducer of which the antenna forms a part, but also masks, obscures or interferes with signals received by the transceiver while the trapped energy is still present within the antenna.

Thus, in any resonant structure, such as a dipole antenna, an impulse signal injected at the antenna input will typically be partially reflected from the open-circuited end of the dipole causing a residual reflected return signal to appear at the antenna input. This return reflection is often referred to as “ringing” or may be referred to as “aperture clutter” since it clutters/obscures the aperture of the antenna.

Pulsed UWB transceiver are often employed in applications such as short-distance positioning, or length measurement and so on, where a pulse e/m signal is transmitted from the transceiver and its reflection subsequently received after a very brief time period. Such an application requires that the entire e/m signal pulse has exited the antenna of the transceiver before any reflection of that signal is expected to be received. This aims to ensure that the transmitted signal does not interfere with its received reflections and thereby obscure the positioning/measurement process.

However, ringing/aperture clutter results in just such obscurement and is highly undesirable.

Prior art pulsed UWB transceiver systems have attempted to overcome this problem by adding e/m signal absorbing material to the ends of the dipole antennas thereof or by loading the antennas with a distributed series of resistors along their length in an attempt to dampen or attenuate the standing waves therein which cause aperture clutter. However, such solutions are generally of little effect or most likely result in undesirably excessive attenuation of received/transmitted signal energy.

Furthermore, short-range positioning antennas are most desirably small in physical size so as to be not only portable but also useable at close quarters and in confined spaces. This requires the antenna to be as small as possible. However, reducing the size of an antenna has, in prior art, typically result in a corresponding reduction of bandwidth.

A physically small broadband UWB antenna with low ringing time was published in UK patent application GB2406220, which is hereby incorporated by reference. This UWB antenna demonstrates good impedance match from 3.5 GHz to 18 GHz which ensures very low ringing from harmonics of the impulse frequency. It also produces a wide elevation beam width of radiated signals and a shallow radiation null along the direction of the geometrical symmetry axis of the radiating element, which one would not expect from a conventional monopole antenna (as one would expect a complete, zero-signal null along the axis of symmetry.

Although the ground plane of the UWB antenna in GB2406220 provides both excellent screening of the associated active circuit from the radiating aperture and may be formed by metallisation of the inter-compartment partition of a hand-held transceiver, the antenna, as a stand-alone component, is a 3-D structure.

Therefore, a small planar antenna structure is desirable for applications which require easy integration of the antenna on a user's clothing or on a PCMCIA PC card for WiFi, Bluetooth and UWB simultaneous applications.

### SUMMARY OF THE INVENTION

The present invention aims to provide an antenna for use in UWB applications, with a general objective to overcome or at least ameliorate the above problems.

In general terms, the invention provides a laminar antenna for use in ultra-wideband communications, the antenna being substantially laminar and comprising:
a first electrically conductive layer forming radiation means operable to form a substantially omnidirectional profile;
a second electrically conductive layer, parallel with the first layer, and providing
a ground plane with respect to the radiation means; and
a dielectric layer separating the first layer from the second layer.

In a first aspect of the present invention, there is provided an antenna printed on a dielectric substrate comprising a radiating element and a transmission line printed on a front surface of the dielectric substrate and a ground element printed on a back surface of the dielectric substrate, the radiating element having a tapered shape with a narrow end connected to a first end of the transmission line, and two opposing edges of the radiating element contiguous to the transmission line, the radiating element further having a v-shaped notch distal from the first end of the transmission line wherein a broader end of the v-shaped notch having two opposing ends contiguous to the opposing edges of the radiating element thereby forming a two symmetrical lobes which diverge with increasing distance from the first end of the transmission line, the opposing edges of the radiating element further having a plurality of serrations along its length thereby forming a slow wave structure for signal propagating along the edges.

The v-shaped notch may be extended into the radiating element with an apex angle less than 90 degrees thereby substantially suppressing transverse signal modes of the radiating element.

Preferably, the serrations are log-periodically distributed such that the radiating element is operable over a wide bandwidth of signal frequencies without increasing size of the radiating element.

Preferably, the serrations are formed to enable an enhanced rate of radiative energy loss along the edge thereby reducing reflection signal travelling back along the edge.

Preferably, the serrations are formed such that each serration tips are formed by the convergence of two serration edges.

The convergence of the two serration tips may be formed at an angle of between approximately 75° and 105°.

Preferably, the serrations are distributed such that corresponding dimensions of successive serrations increase log-periodically whereby the ratio of the corresponding dimensions in respect of successive serrations has constant predetermined ratio value.

Preferably, the serrations of the opposing edges are arranged symmetrically such that one is the mirror image of the other along a line extending through the radiating element from the transmission line and between the two edges.

In one configuration of the above aspect, the ground element has a plurality of slots spaced apart from each other at irregular intervals along two longitudinal edges thereby suppressing resonance of the radiating element, the longitudinal edges of the ground plane being parallel to the transmission line.

Preferably, the slots have different lengths.

Preferably, the transmission line has a second end connected to a signal feed point supplying input signal therefrom.

Preferably, the signal feed point is located between the transmission line and the ground element.

In a further independent aspect there is provided an antenna printed on a first dielectric substrate comprising a radiating element and a transmission line printed on a front surface of a first dielectric substrate, a ground element printed on a back surface of the first dielectric substrate, and an RF shield superimposed on the front surface of the first dielectric substrate and separated by a second dielectric substrate, the radiating element having a tapered shape with a narrow end connected to a first end of the transmission line, and two opposing edges of the radiating element contiguous to the transmission line, the radiating element further having a v-shaped notch distal from the first end of the transmission line wherein a broader end of the v-shaped notch having two opposing ends contiguous to the opposing edges of the radiating element thereby forming a two symmetrical lobes which diverge with increasing distance from the first end of the transmission line, the opposing edges of the radiating element further having a plurality of serrations along its length thereby forming a slow wave structure for signal propagating along the edges.

Preferably, the ground element is generally ‘I’ shaped and the ground element has a plurality of slots spaced apart from each other at irregular intervals along its top side arms.

Preferably, the plurality of slots is parallel to the transmission line.

Preferably, the ground element has a plurality of vias that electrically connects the ground element through the first and second dielectric substrate to the RF shield thereby further reducing ringing of the radiating element.

Preferably, the RF shield is generally ‘T’ shaped resembling a top portion of the ‘I’ shaped ground element.

Preferably, the transmission line has a second end connected to a signal feed point supplying input signal therefrom.

In another embodiment of the above aspects, the radiating element may be operable to form a substantially unidirectional profile when the antenna is deployed in close proximity to a second ground plane.

In a further independent aspect there is provided an antenna for use in ultra wideband communications, the antenna comprising: a laminar dielectric substrate, defining first and second opposing planar surfaces and a connection point for establishing electrical connection with the antenna, a transmission element formed on the first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from the transmission line, wherein outer edges of the lobes have formed therein a plurality of serrations to inhibit propagation of signal waves at the outer edges, and a ground element formed on the first planar surface, substantially corresponding to the extent of the transmission line, the transmission line having a perimeter thereby separating the ground element and the transmission line to provide a coplanar waveguide structure in respect of the radiating element.

Preferably, the ground element has a plurality of slots spaced apart from each other at irregular intervals along its two longitudinal edges thereby suppressing resonance of the radiating element, the two longitudinal edges of the ground plane being parallel to the transmission line.

Preferably, the slots have different lengths.

In a further independent aspect there is provided a method of manufacturing an antenna structure, comprising: providing a radiating element and a transmission line on a first surface of a substantially planar dielectric substrate, and providing a ground element on a second surface of the dielectric substrate, the radiating element is shaped as a tapered shape with a narrow end connected to a first end of the transmission line, and two opposing edges of the radiating element contiguous to the transmission line, the radiating element further having a v-shaped notch distal from the first end of the transmission line wherein a broader end of the v-shaped notch having two opposing ends contiguous to the opposing edges of the radiating element thereby forming a two symmetrical lobes which diverge with increasing distance from the first end of the transmission line, the opposing edges of the radiating element further having a plurality of serrations along its length thereby forming a slow wave structure for signals propagating along the edges.

The v-shaped notch may be extended into the radiating element with an apex angle less than 90 degrees thereby substantially suppressing transverse signal modes of the radiating element.

Preferably, the plurality of serrations are log-periodically shaped such that the radiating element is operable over a wide bandwidth of signal frequencies without increasing the size of the radiating element.

Preferably, the plurality of serrations is arranged to enable an enhanced rate of radiative energy loss along the edge thereby reducing reflection signal travelling back along the edge.

Preferably, the serrations are formed such that each serration tip is formed by the convergence of two serration edges.

Preferably, the serration tip is formed at an angle of between 75° and 105°.

Preferably, the serrations are shaped such that corresponding dimensions of successive serrations increase log-periodically whereby the ratio of the corresponding dimensions in respect of successive serrations has constant predetermined ratio value.

Preferably, the serrations of the opposing edges are arranged symmetrically such that one is the mirror image of the other along a line extending through the radiating element from the transmission line and between the two edges.

Preferably, the ground element has a plurality of slots spaced apart from each other at irregular intervals along two longitudinal edges thereby suppressing resonance of the radiating element, the longitudinal edges of the ground plane being parallel to the transmission line.

Preferably, the plurality of slots have different lengths.

Preferably, the transmission line has a second end connected to a signal feed point supplying input signal therefrom.

Preferably, the signal feed point is located between the transmission line and the ground element.

In a further independent aspect there is provided a method of manufacturing an antenna printed on a first dielectric substrate comprising: providing a radiating element and a transmission line printed on a first surface of a substantially planar first dielectric substrate, a ground element printed on a second surface of the first dielectric substrate, and an RF shield superimposed on the front surface of the first dielectric substrate and separated by a second dielectric substrate, the radiating element having a tapered shape with a narrow end connected to a first end of the transmission line, and two opposing edges of the radiating element contiguous to the transmission line, the radiating element further having a v-shaped notch distal from the first end of the transmission line wherein a broader end of the v-shaped notch having two opposing ends contiguous to the opposing edges of the radiating element thereby forming a two symmetrical lobes which diverge with increasing distance from the first end of the transmission line, the opposing edges of the radiating element further having a plurality of serrations along its length thereby forming a slow wave structure for signals propagating along the edges.

Preferably, the ground element is generally ‘I’ shaped and the ground element has a plurality of slots spaced apart from each other at irregular intervals along its top side arms.

Preferably, the plurality of slots is parallel to the transmission line.

Preferably, the ground element has a plurality of vias that electrically connects the ground element through the first and second dielectric substrate to the RF shield thereby further reducing ringing of the radiating element.

Preferably, the RF shield is generally ‘T’ shaped resembling a top portion of the ‘I’ shaped ground element.

Preferably, the transmission line has a second end connected to a signal feed point supplying input signal therefrom.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows a plane view of a front surface of an antenna in accordance with a first embodiment of the present invention;

FIG. 2 shows a plane view of a back surface of an antenna in accordance with a first embodiment of the present invention;

FIG. 3 shows a side view of an antenna in accordance with a first embodiment of the present invention;

FIG. 4 shows a plane view of a front surface of an antenna in accordance with a second embodiment of the present invention;

FIG. 5 shows a plane view of a back surface of an antenna in accordance with a second embodiment of the present invention;

FIG. 6 shows a side view of an antenna in accordance with a second embodiment of the present invention;

FIG. 7 shows a side view of an antenna in accordance with an embodiment of the present invention;

FIG. 8 shows a plane view of an array of antennas in accordance with an embodiment of the present invention;

FIG. 9 shows a side view of an array of antennas in accordance with an embodiment of the present invention;

FIG. 10 shows a plane view of an antenna in accordance with a third embodiment of the present invention;

FIG. 11 shows a side view of an antenna in accordance with a third embodiment of the present invention.

### DETAILED DESCRIPTION

The present invention will be described in further detail on the basis of the attached diagrams.

In the following description, a number of specific details are presented in order to provide a thorough understanding of embodiments of the present invention. It will be apparent, however, to a person skilled in the art that these specific details need not be employed to practice the present invention.

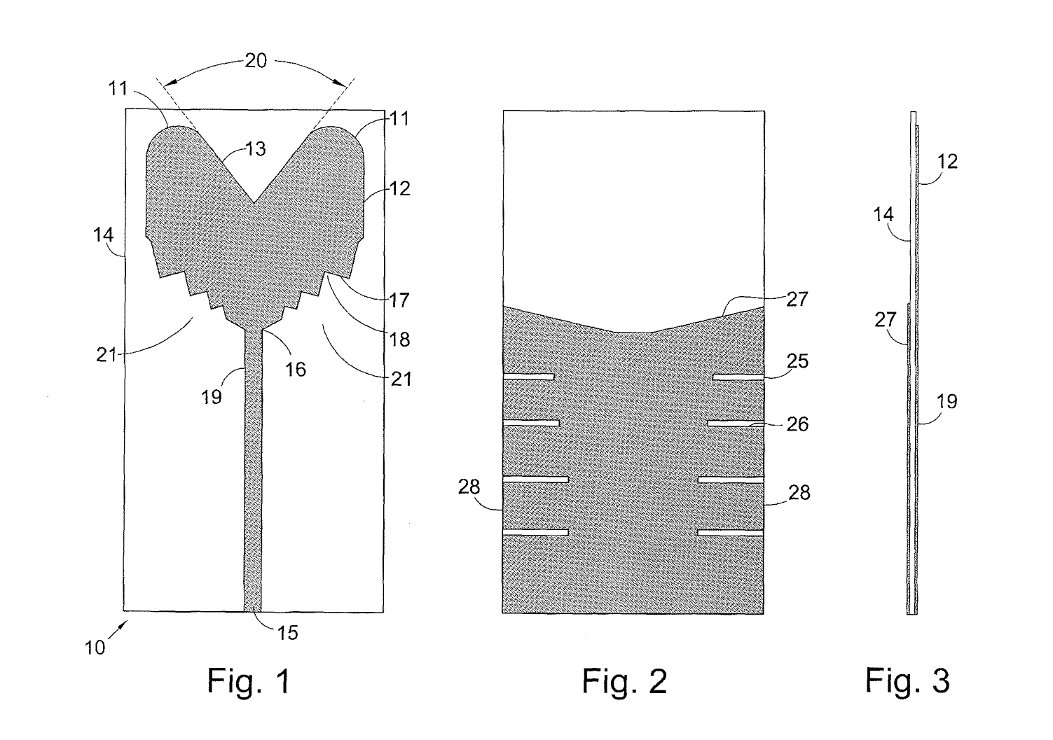

FIGS. 1 to 3 show different views of a planar antenna 10 produced on a dielectric substrate 14 metallised on both its faces. The planar antenna is capable of being utilised in transmission and reception.

FIG. 1 shows a front surface of the planar antenna 10 comprising a radiating element 12 and a microstrip feed line 19 printed on the dielectric substrate 14. The microstrip feed line 19 has a signal feed point 15 to provide (and to receive) signal to and from the radiating element.

The opposing end of the signal feed point of the microstrip feed line is connected to the radiating element 12. The radiating element 12 is shaped as a segment having two opposed slant edges 21, which diverge outwardly from an apex 16 of the segment.

The two opposed slant edges 21 diverge with increasing distance from the microstrip feed line 19 such that the radiating element 12 tapers outwardly from the feed line 19. The radiating element 12 possesses two distal peripheral edges (11 and 13) which respectively bridge the terminal outermost ends of the two opposed slant edges 21 and form the curved outermost peripheries of the radiating element 12.

The radiating element 12 has two corresponding series of serrations 17 each formed within a respective one of the two opposed slant edges 21. Each serration of a given series of serrations is formed by a pair of successive angular (tapering) notches 18 which extend into the radiating element 12 from the respective slant edge 21. Each tapering notch has notch edges which converge to terminate within the radiating element 12 at a right-angled apex 18.

Each such serration, and the series of serrations 17 collectively, present a slow-wave structure to a signal propagating along the slant edge 21. Essentially, the slow-wave structure formed along the slant edge 21 of the radiating element 12 is provided with a meander which slows down the progress of a signal wave travelling along the slant edge 21. This is achieved by constraining the signal wave to progress along the longer meandering slant edge rather than to progress directly along a shorter linear slant edge. As a result, the radiating element is operable over a wide bandwidth of signal frequencies without increasing the physical size of the radiating element 12.

The meanders of the slant edge 21 are shaped such that the Q-factor of the antenna is minimised thereby reducing aperture clutter by reducing the relative magnitude of a signal reaching the terminal (open circuit) end of the slant edge 21 where signal reflection tends to occur, this being the source aperture clutter. The Q-factor of the radiating element 12 is given as:

$$Q factor ∝ \frac{stored energy}{rate of energy loss}$$

Thus, the relative magnitude of a signal reaching the terminal outer edge of the slant edge (i.e. relative to the magnitude of that signal at the beginning of the slant edge) is sensitively dependent upon the rate of loss of energy from the signal during propagation along the slant edge. By suitably shaping the meanders of the slow-wave structure, the present invention may enhance the rate of radiative energy loss of the propagating signal as it progresses along the slant edge thereby reducing aperture clutter.

Successive serrations of each series of serrations are shaped to increase in size relative to the preceding serrations in a log-period manner. Thus, the serrations in a given series have a common shape. In this example the common shape is a straight-edged serration with two tapering edges extending from the body of the radiating element 12 at predetermined angles and converging at increasing distance from the body of the radiating element 12 to a terminal right-angular serration tip or apex 18.

A successive serration in a given series of serrations 17 possess two tapering edges which each extend from the body of the radiating element 12 at the same predetermined angles as occurs in respect of the edges of the preceding serration of the series, and also converge at a right angular serration apex 18. The ratio of the lengths of the two tapering edges of any given serration is shared by all serrations in the same series since all serrations in a given series share the same general shape. However, due to log-periodic scaling, the lengths themselves increase by a predetermined scaling value such that the ratio of a serration edge length of a given serration and the corresponding edge length of the succeeding serration has a constant predetermining ratio value shared by all such neighbouring serrations.

Furthermore, each series of serrations 17 is arranged such that the distance between the location of the apex 16 of the segment of the radiating element 12 and the location of the serration increase log-periodically as one encounters successive serrations of a given series. The result is that the ratio of the aforesaid distance, as between two neighbouring (successive) serrations, is equal to a constant predetermined ratio value shared by all such neighbouring serrations. The location of the serration may be considered to be the location of the apex 18 of the tip of the serration in question, for example.

The planar antenna 10 also includes a ground plane 27 printed on a back surface of the planar antenna 10 as shown in FIG. 2.

In order to design an antenna which is capable of operating over a wide bandwidth, biasing and impedance effects of the associated DC networks must be considered from an RF or microwave perspective. DC biasing achieved from the use of RF chokes and resistors is effective only if the chokes are effectively an open circuit with no resonances, and if the combinations of inductance, resistance and capacitance do not limit the ability of the circuit to respond broad band.

The ground plane 27 comprises a plurality of slots 25 along its two longitudinal edges 28. The slots 25 along the longitudinal edges 28 have different lengths 26 and are spaced from each other at irregular intervals. In this configuration, the slots are essentially series inductance that function as RF choke to attenuate any unwanted signals.

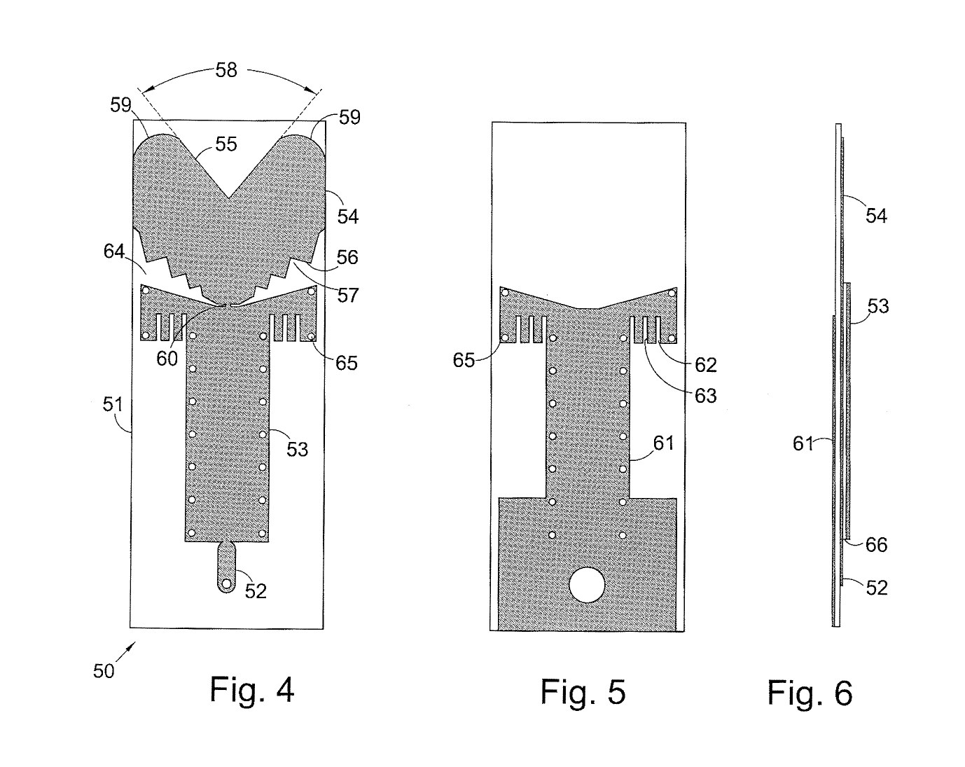

FIGS. 4 to 6 show different views of an alternative planar antenna configuration 50 according to the present invention. As shown in FIG. 4, the structure and functional features of the radiating element 54 are substantially the same as the corresponding features of the radiating element 12 illustrated in FIG. 1.

As shown in FIG. 5, the configuration of the ground plane 61 is different from the configuration of the ground plane 27 shown in FIG. 1. The ground plane 61 has an “I” shaped configuration. The RF chokes are distributed along the top upper arms of the “I” shaped ground plane. The functional features of the slots 62 in FIG. 5 are the same as the functional features of the slots 25 shown in FIG. 2, i.e. they function as an RF choke. In addition, the antenna 50 in FIG. 4 to 6 also includes an RF shield 53 which is located above the microstrip feed line 52. The RF shield is printed on a front surface of a second dielectric substrate 66. The RF shield 53 located on the top surface is electrically connected with the ground plane 61 through a plurality of vias 65 which extend through the substrate 51 and substrate 66.

The antennas illustrated in FIGS. 1 to 6 and FIGS. 10 and 11 are “omni-directional” being unlimited in their azimuthal direction of radiation. It has been found that the 140 degrees (10 dB) elevation beamwidth extends from about −60 degrees to about +80 degrees relative to the position of the ground plane. The antenna radiates omni-directionally about its geometrical axis, having a linear polarisation coincident with its geometrical axis.

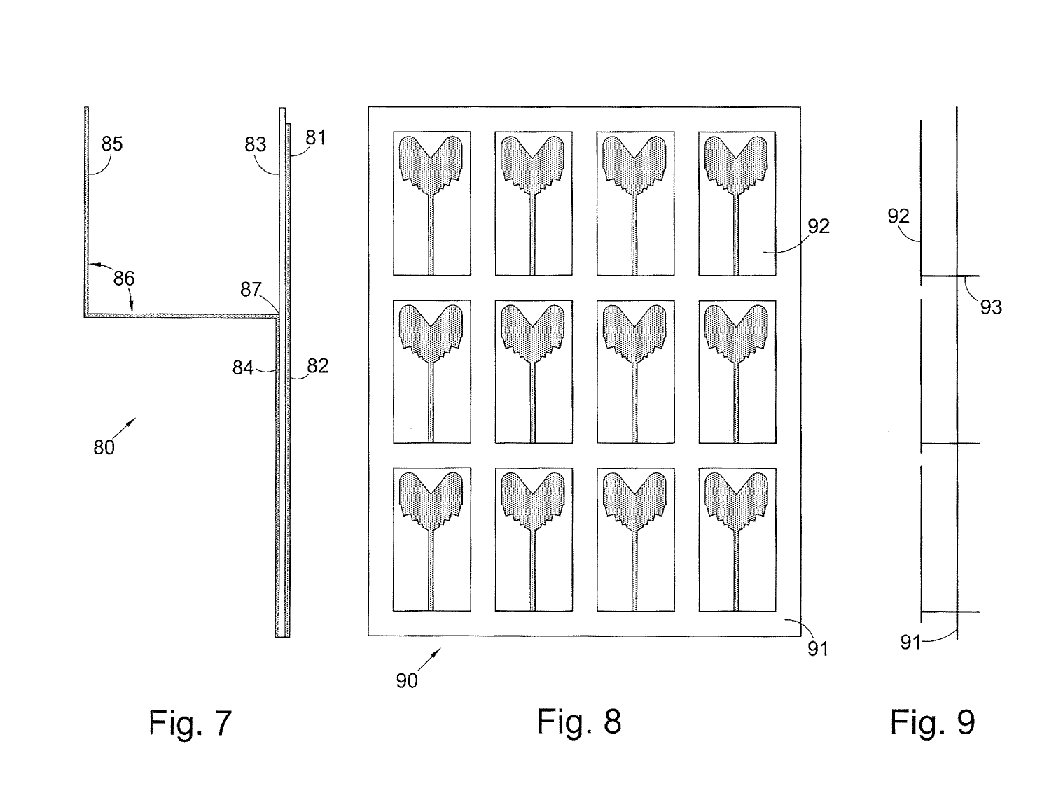

FIG. 7 shows the side view of any one of the above planar antennas (10 or 50) being arranged with a second ground plane 85. Again, the structure and functional features of the radiating element 81 are substantially the same as the corresponding features of the radiating element 12 and 54 illustrated in FIGS. 3 and 6 respectively. The second ground plane 85 joins the edge 87 contiguous to the ground plane 84 integral to the antenna structure 80 and is arranged to extend substantially perpendicularly from the integral ground plane 84. The second ground plane is folded at a corner 86 at an angle of 90° in the present example. The second ground plane essentially functions as a reflector such that the antenna is unidirectional and radiates a majority of the signal wave into the space away from the second ground plane.

The person skilled in the art will appreciate the above described antennas can also be arranged as a planar antenna array. FIG. 8 shows the antenna structure 92 being arranged in an array above a common ground plane 91.

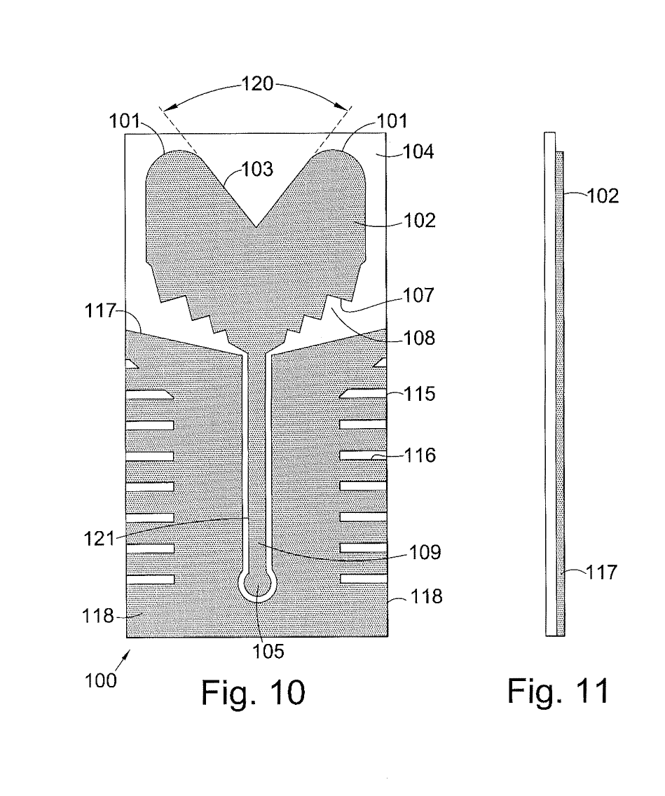

FIGS. 10 to 11 show different views of an alternative planar antenna configuration 100 according to the present invention. As shown in FIG. 10, the structure and functional features of the radiating element 102 are substantially the same as the corresponding features of the radiating element 12 and 54 illustrated in FIGS. 3 and 6 respectively.

As shown in FIG. 10, the ground plane 117 of the antenna 100 is formed on the same surface as the radiating element 102. The ground plane 117 is separated from transmission line 109 and the feed point 105 by the substrate 104 around the perimeter 121 of the transmission line 109 and feed point 105 thereby forming a coplanar waveguide structure. The ground plane 117 comprises a plurality of slots 115 along its two longitudinal edges 118. The slots 115 along the longitudinal edges 118 have different lengths 116 and are spaced from each other at irregular intervals. The functional features of the slots 115 in FIG. 10 are the same as the functional features of the slots 25 shown in FIG. 2, i.e. they function as an RF choke to attenuate any unwanted signals.

This configuration has an advantage in that all the metallisation is formed on one surface of the dielectric substrate. This allows surface mount components for the associated circuitry to be mounted on the opposing surface, which is particularly useful for PCMCIA PC card applications.

Thus, the present invention, for example, as shown in the above embodiments, may provide an ultra wide-band (UWB) electromagnetic impulse transceiver for applications in short range communications and/or positioning systems. The invention may be implemented in the form of a monopole antenna thereby obviating the need for a balun with the antenna circuitry. The antenna according to the present invention in any of its embodiment has the important benefit of being sufficiently small for use as a portable impulse transceiver.

Furthermore, monopole antennas structured according to the present invention in its first aspect display up to a decade of bandwidth, have reduced aperture clutter with moderate signal loss and have relatively small physical size.

The antennas illustrated in FIGS. 1 to 3 and FIGS. 4 to 6 are “omni-directional” being unlimited in their azimuthal direction of radiation. It has been found that the 140 degrees (10 dB) elevation beamwidth extends from about −60 degrees to about +80 degrees relative to the position of the ground plane.

The planar structure of the antenna is also easy to manufacture in large volumes. Furthermore, the associated electronics components of a PCMCIA PC card can be incorporated on the same substrate as the planar structure of the antenna. This is also useful in other applications, especially for antennas that are integrated on a user's clothing.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

1. An antenna for use in ultra wideband communications, the antenna comprising:
a laminar dielectric substrate, defining first and second opposing planar surfaces and a connection point for establishing electrical connection with the antenna;
a transmission element formed on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit propagation of signal waves at said outer edges; and
a ground element formed on said second planar surface, the ground element being connected to said connection point to provide a ground plane in respect of said radiating element.

2. The antenna in accordance with claim 1, wherein said v-shaped notch extends into said radiating element with an apex angle less than 90 degrees thereby substantially suppressing transverse signal modes of said radiating element.

3. The antenna in accordance with claim 1, wherein said serrations are log-periodically distributed such that said radiating element is operable over a wide bandwidth of signal frequencies without increasing size of said radiating element.

4. The antenna in accordance with claim 1, wherein said serrations are formed to enable an enhanced rate of radiative energy loss along said edge thereby reducing reflection signal travelling back along said edge.

5. The antenna in accordance with claim 1, wherein said serrations are formed such that each serration tip is formed by the convergence of two serration edges.

6. The antenna in accordance with claim 5, wherein said convergence of said two serration edges is formed at an angle of between approximately 75° and 105°.

7. The antenna in accordance with claim 1, wherein said serrations are distributed such that corresponding dimensions of successive serrations increase log-periodically whereby the ratio of said corresponding dimensions in respect of successive serrations has constant predetermined ratio value.

8. The antenna in accordance with claim 1, wherein said serrations of said opposing edges are arranged symmetrically such that one is the mirror image of the other along a line extending through the radiating element from said transmission line and between said two edges.

9. The antenna in accordance with claim 1, wherein said ground element has a plurality of slots spaced apart from each other at irregular intervals along its two longitudinal edges thereby suppressing resonance of said radiating element, said two longitudinal edges of said ground plane being parallel to said transmission line.

10. The antenna in accordance with claim 9, wherein said slots have different lengths.

11. The antenna in accordance with claim 1, wherein said transmission line has a second end connected to said connection point supplying input signal therefrom.

12. The antenna in accordance with claim 11, wherein said connection point is located between said transmission line and said ground element.

13. An antenna for use in ultra wideband communications, the antenna comprising:
a laminar dielectric substrate, defining first and second opposing planar surfaces and a connection point for establishing electrical connection with the antenna;
a transmission element formed on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit propagation of signal waves at said outer edges;
a ground element formed on said second planar surface, the ground element being connected to said connection point to provide a ground plane in respect of said radiating element; and
a second laminar dielectric substrate, defining third and fourth opposing planar surfaces; said third planar surface being superimposed on said first planar surface;
a conductive element formed on said fourth planar surface, the conductive element being connected to said ground element to provide an RF shield in respect of said transmission line.

14. The antenna in accordance with claim 13, wherein said ground element is generally ‘I’ shaped and said ground element has a plurality of slots spaced apart from each other at irregular intervals along its top side arms.

15. The antenna in accordance with claim 14, wherein said slots are parallel to said transmission line.

16. The antenna in accordance with claim 13, wherein said ground element has a plurality of vias that electrically connect said ground element through said first and second laminar dielectric substrate to said conducting element thereby further reducing ringing of said radiating element.

17. The antenna in accordance with claim 13, wherein said conducting element is generally ‘T’ shaped resembling a top portion of said ‘I’ shaped ground element.

18. The antenna in accordance with claim 13, wherein said transmission line has a second end connected to said connection point supplying input signal therefrom.

19. The antenna in accordance with claim 1, wherein said radiating element is operable to form a substantially unidirectional profile when said antenna is deployed in close proximity to a second ground plane.

20. An antenna for use in ultra wideband communications, the antenna comprising:
a laminar dielectric substrate, defining first and second opposing planar surfaces and a connection point for establishing electrical connection with the antenna;
a transmission element formed on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit propagation of signal waves at said outer edges; and
a ground element formed on said first planar surface, substantially corresponding to the extent of said transmission line, said transmission line having a perimeter thereby separating said ground element and said transmission line to provide a coplanar waveguide structure in respect of said radiating element.

21. The antenna in accordance with claim 20, wherein said ground element has a plurality of slots spaced apart from each other at irregular intervals along its two longitudinal edges thereby suppressing resonance of said radiating element, said two longitudinal edges of said ground plane being parallel to said transmission line.

22. An antenna in accordance with claim 21, wherein said slots have different lengths.

23. A method of making an antenna structure, comprising:
providing a laminar dielectric substrate, defining first and second opposing planar surfaces and a connection point for establishing electrical connection with the antenna;
forming a transmission element on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit formation of slow waves in said lobes; and
forming a ground element on said second planar surface, the ground element being connected to said connection point to provide a ground plane in respect of said radiating element.

24. The method in accordance with claim 23, wherein said v-shaped notch extends into said radiating element with an apex angle less than 90 degrees thereby substantially suppressing transverse signal modes of said radiating element.

25. The method in accordance with claim 23, wherein said serrations are log-periodically shaped such that said radiating element is operable over a wide bandwidth of signal frequencies without increasing size of said radiating element.

26. The method in accordance with claim 23, wherein said serrations are formed to enable an enhanced rate of radiative energy loss along said edge thereby reducing reflection signal travelling back along said edge.

27. The method in accordance with claim 23, wherein said serrations are formed such that each serration tips are formed by the convergence of two serration edges.

28. The method in accordance with claim 27, wherein said convergence of said two serration tips are formed at an angle of between approximately 75° and 105°.

29. The method in accordance with claim 23, wherein said serrations are shaped such that corresponding dimensions of successive serrations increase log-periodically whereby the ratio of said corresponding dimensions in respect of successive serrations has constant predetermined ratio value.

30. The method in accordance with claim 23, wherein said serrations of said opposing edges are arranged symmetrically such that one is the mirror image of the other along a line extending through the radiating element from said transmission line and between said two edges.

31. The method in accordance with claim 23, wherein said ground element have a plurality of slots spaced apart from each other at irregular intervals along two longitudinal edges thereby suppressing resonance of said radiating element, said longitudinal edges of said ground plane being parallel to said transmission line.

32. The method in accordance with claim 31, wherein said slots have different lengths.

33. The method in accordance with claim 23, wherein said transmission line has a second end connected to said connection point supplying input signal therefrom.

34. The method in accordance with claim 33, wherein said connection point is located between said transmission line and said ground element.

35. A method of making an antenna structure, comprising:
providing a laminar dielectric substrate, defining first and second opposing planar surfaces and a connection point for establishing electrical connection with the antenna;
forming a transmission element on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit formation of slow waves in said lobes;
forming a ground element on said second planar surface, the ground element being connected to said connection point to provide a ground plane in respect of said radiating element; and
providing a second laminar dielectric substrate, defining third and fourth opposing planar surfaces; said third planar surface being superimposed on said first planar surface;
forming a conductive element on said fourth planar surface, the conductive element being connected to said ground element to provide an RF shield in respect of said transmission line.

36. The method in accordance with claim 35, wherein said ground element is generally ‘I’ shaped and said ground element has a plurality of slots spaced apart from each other at irregular intervals along its top side arms.

37. The method in accordance with claim 35, wherein said plurality of slots is parallel to said transmission line.

38. The method in accordance with claim 35, wherein said ground element has a plurality of vias that electrically connect said ground element through said first and second laminar dielectric substrate to said conducting element thereby further reducing ringing of said radiating element.

39. The method in accordance with claim 35, wherein said conducting element is generally ‘T’ shaped resembling a top portion of said ‘I’ shaped ground element.

40. The method in accordance with claim 35, wherein said transmission line has a second end connected to said connection point supplying input signal therefrom.

41. A method of making an antenna structure comprising:
providing a laminar dielectric substrate, defining first and second opposing planar surfaces and a connection point for establishing electrical connection with the antenna;
forming a transmission element formed on said first planar surface, the transmission element comprising a radiating element and a transmission line providing electrical connection between the radiating element and the connection point, the radiating element being substantially tapered towards a narrow end thereof connected with the transmission line, the distal, wider end thereof having formed therein a substantially v-shaped notch thereby defining two lobes which diverge with increasing distance from said transmission line, wherein outer edges of said lobes have formed therein a plurality of serrations to inhibit propagation of signal waves at said outer edges; and
forming a ground element formed on said first planar surface, substantially corresponding to the extent of said transmission line, said transmission line having a perimeter thereby separating said ground element and said transmission line to provide a coplanar waveguide structure in respect of said radiating element.

42. The method in accordance with claim 41, wherein said ground element has a plurality of slots spaced apart from each other at irregular intervals along its two longitudinal edges thereby suppressing resonance of said radiating element, said two longitudinal edges of said ground plane being parallel to said transmission line.

43. The method in accordance with claim 42, wherein said slots have different lengths.

44-45. (canceled)
